(19) United States
(12) Patent Application Publication
(10) Pub. No.: US 2013/0268869 A1
(43) Pub. Date: Oct. 10, 2013

(54) VIRTUAL MESSAGING

(71) Applicant: Be Labs, LLC, Seattle, WA (US)

(72) Inventor: Edward Balassanian, Seattle, WA (US)

(21) Appl. No.: 13/668,536

(22) Filed: Nov. 5, 2012

Related U.S. Application Data
(60) Provisional application No. 61/556,018, filed on Nov. 4, 2011.

(51) Int. Cl. H04L 29/06

(52) U.S. Cl. CPC H04L 65/403
USPC 715/753

(57) ABSTRACT

Disclosed is a system and method for reserving a specific geographical location in a virtual environment corresponding to the real world.

The present inventive system and method relates to a service provided on a computer network. The service provides users with a virtual representation of one or more geographical locations that correspond to the real world. For example and without limitation, there may be a map of Seattle on a web page. The service permits one or more individuals (or entities, groups, or any other potential users of the service) to “reserve” areas within the virtual representation of the one or more geographic locations. For example and without limitation, a merchant may “reserve” the University of Washington football stadium (“Husky Stadium”) in Seattle. The merchant's reservation may permit the merchant to have exclusive control over a virtual “wall” of data (or a plurality of walls) located at the reserved area (or areas) within the virtual representation of the one or more geographic locations. Consequently, the reservation. of an area may be equivalent to the reservation of a wall. In this application, parties who reserve one or more walls are referred. to as “merchants”.

One or more individuals (or entities, groups, or any other potential users of the service) may access the virtual representation of the one or more geographic locations provided by the system and may post content on one or more walls. Such parties are referred to herein as “users”. A merchant may be a user—the merchant may reserve a wall and post on it—but a user is not necessarily a merchant. A user may be someone who accesses the virtual representation of the one or more geographic locations, and posts on one or more walls without having reserved any of the walls on which the user posts.

Reservation of a particular area may allow a merchant to provide content at a given virtual location, as well as a specific time or event or period of time. The service may enable advertisements to be presented to users. The advertisements may be specific to the user's virtual geographical, location, as well as to a particular time or event or period of time. The user may select a virtual geographical location. Alternatively, the virtual geographic location may be provided for the user—for example and without limitation, it may correspond to the user's real-world geographic location, as indicated by a GPS device.

### BACKGROUND

Social networking websites allow users to submit messages (known as posts or postings) to share with their friends. Facebook, MySpace and Twitter are common social networking websites among many in the field. In general, each user creates an account profile page, connects to his or her friends and posts messages on his or her profile page or friends' pages. The profile page shows the messages posted by one or more connected users in a stream (Twitter) or on a wall (Facebook). Additionally, these services allow their users to share photos, videos and other personal information with their connected friends.

A variety of social media applications provide mechanisms for individuals to share multimedia content with one or more individuals. Facebook, Instagram, Piictu and LiveStream are examples of social media services that provide functionality within their application that enables a user to post multi-media content. Each message is one of, or a combination of; text, pictures, video, audio, doodles or other content.

Prior art provides individuals with the ability to post messages to those within the social network, but these services do not link the messages with a particular virtual location or a specific time or time period or event.

Accordingly, the aforementioned services are limited in ability to provide real-time and contextually relevant advertisements to a user.

Further, prior art does not provide coupons or rewards that correspond with either a user's specific virtual location or with a specific time or event or time period.

A solution that allows merchants to reserve a geographical location in a virtual environment has eluded those skilled in the art, until now.

A solution that provides an individual with a visual virtual wall to aggregate user provided messages from a specific time and a specific geographical location, has eluded those skilled in the art, until now.

A solution that provides a merchant the ability to target users based on their location and time, has eluded those skilled in the art, until now.

It would be advantageous to provide an online service that enables merchants to create a virtual wall at a specific virtual geographical location for a specific period of time.

It would also be advantageous to provide a system that enables the posting of messages to be restricted to a specific virtual geographical location and time period.

It would also be advantageous to provide a system that enables merchants to target advertisements to individuals at a specific location and time.

### SUMMARY

In accordance with the present disclosure, there is provided a system and method for reserving a specific geographical location in a virtual environment corresponding to the real world. A merchant may reserve a virtual wall in virtual location corresponding to a location in the real world. A merchant's ability to reserve a wall may be related to one or more variables such as, location, location type, size of area, and length of time. The system may provide a mechanism by which users, located at a specific geographical location during a specified time or event or time period, may upload content for display on a virtual wall. Further, advertisements can be placed is relation to the wall or provided to users uploading content while at a specific location and time. Merchants may place virtually decorative items on or in relation to their wall for display.

### BRIEF DESCRIPTION OF THE DRAWINGS

An understanding of the present disclosed system and method may be obtained by reference to the accompanying drawings, when considered in conjunction with the subsequent, detailed. description, in which:

FIG. 1 is an illustration of one embodiment of the system and its components;

FIG. 2 is an illustration of one embodiment of a webpage for selecting a specific wall location on a digital map;

FIG. 3 is a flow chart detailing one embodiment of the wall reservation process;

FIG. 4 is an illustration of one embodiment of a virtual wall combining various media types;

FIG. 5 is an illustration of one embodiment of a virtual wall message;

FIG. 6 is an illustration of one embodiment of a virtual wall with epoch indicators;

FIG. 7 is an illustration of one embodiment of a virtual wall with a list of messages from a user selected epoch indicator;

FIG. 8 is an illustration of one embodiment of a virtual wall and selecting a beginning message of an epoch;

FIG. 9 is an illustration of one embodiment of a virtual wall and selecting an end message of an epoch;

FIG. 10 is an illustration oil one embodiment of a virtual wall and naming an epoch;

FIG. 11 is an illustration of another embodiment of a virtual wall, and naming an epoch;

FIG. 12 is a flow chart detailing one embodiment of a process for determining the locations within which a user may post a message on a wall;

FIG. 13 is an illustration of one embodiment of a mobile application for posting a message;

FIG. 14 is a flow chart of one embodiment of a process for providing a location-based coupon after a user posts a message.

FIG. 15 is a flow chart detailing one embodiment of an email receipt and processing of images.

### DETAILED DESCRIPTION

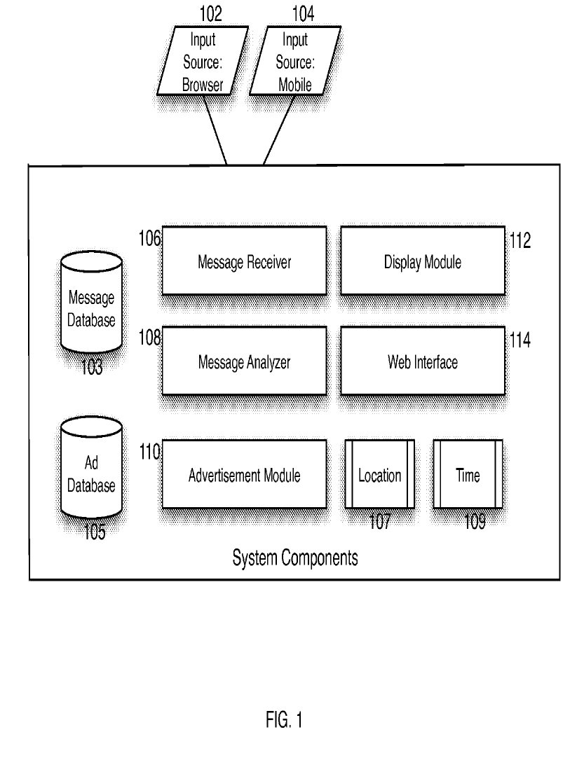

FIG. 1 is an illustration of the components that comprise the system described in detail below. In one embodiment, the system includes a message receiver module 106 configured to receive input from multiple types of input sources. For example, the an input source can be a browser executing on a personal computer 102 or a mobile device 104. The system includes databases to store message data 103 and advertisement data 105. The advertisement module 110 provides a portal and management tools for merchants. A location module 107 is employed to ensure the validity of the geographical location of a user submitting a message in conjunction with the user's submission of the message. A time module 109 is employed to ensure the time a message is submitted to the system is valid. A message analyzer module 108 is employed to analyze messages as configured by the system. A display module 112 is used to arrange the messages. The web interface module 114 is responsible for the web pages relating to the system and its services.

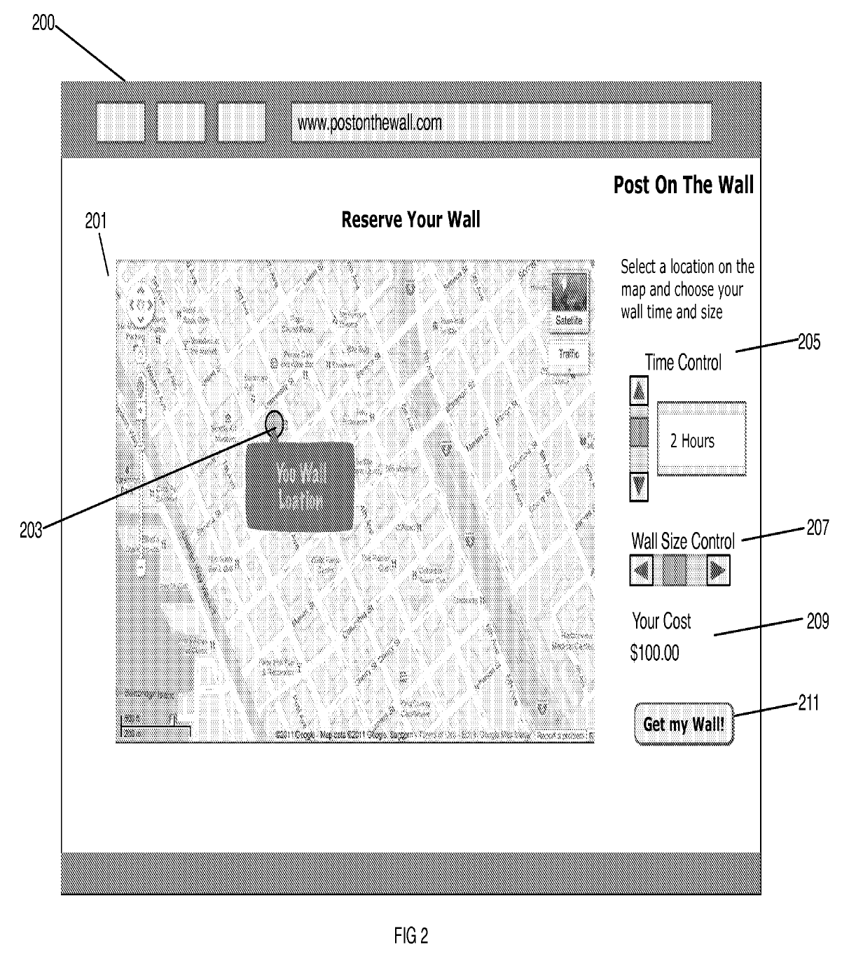

FIG. 2 is an illustration of a webpage configured to select a location on a digital map to place a virtual wall. In the illustrated embodiment, the browser 200 contains a webpage from postonthewall.com. The digital map 201 displayed is rendered from a plug-in, which may be provided by a third party map service such as Google Maps, Bing Maps, Mapquest or other. A merchant selects a location on a map 203 where the merchant wants a virtual wall to be located. Selecting a location can be done by use of a cursor or entering a specific address. Once a location has been inputted, the merchant adjusts the duration of time a wall is active 205 and the size of the wall 207. The time can be adjusted and reserved in increments of hours, days, weeks, and months. The size of the wall is the geographical area a merchant wants to enable users to post messages on a wall. Default size, and size increments or restrictions are configurable by the system.

In a further embodiment, the merchant sets the wall visibility to one of private or public. A wall with a visibility setting of private is a wall wherein only invited or authorized users can post messages. A wall with a visibility setting of public is a wall wherein anyone at the specified location, during the specified time, can post a message.

The system displays the cost 209 in real-time as a merchant adjust one or more configurable settings. Once the location, time, size and other configurable options have been set, the merchant reserves the wall, 211.

In a further embodiment, the system can impose limits on the geographical range of a wall and the length of time a wall can exist.

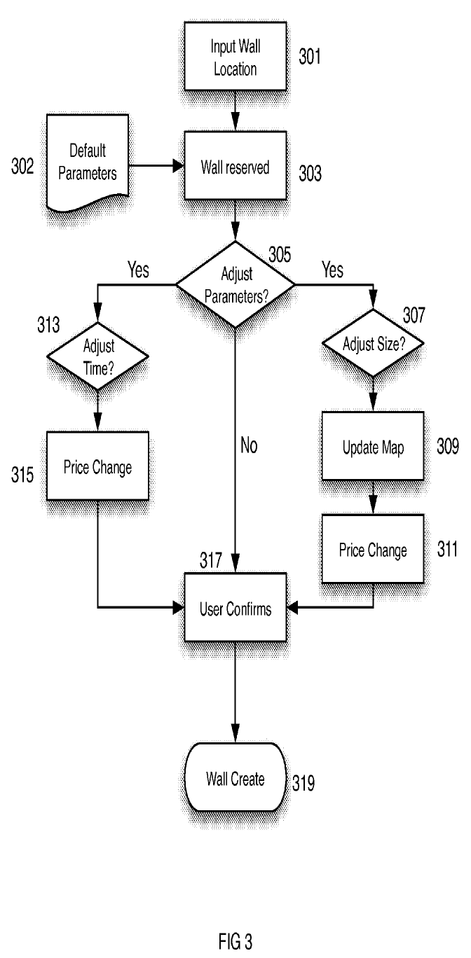

FIG. 3 is a flow chart detailing one embodiment of the wall reservation process. The process begins 301 with the merchant inputting a specific geographical location for a wall. A wall is temporarily reserved 303 with the default system parameters 302 for a virtual wall. Next, the merchant has the option 305 to adjust one or more parameters relating to the virtual wall. If the merchant adjusts time 313, then the price is changed respectively 315. If the merchant adjusts size 307 then the visual indicator on a map is updated 309 and the price is changed respectively 311. Upon completion of adjusting wall options the merchant confirms 317. The merchant also has the option of selecting the default options and confirming 317 without adjusting parameters. Upon confirmation, the wall is created 319. During the confirmation process a merchant may be asked to provide payment if there is a cost associated with the virtual wall. A method by which the merchant is charged for the cost of the wall may be built into the system.

In one embodiment, for purposes of simplicity in illustration, only two options are provided for a merchant to adjust. It is understood that any number of configurations, or no configurations, can be provided to a merchant.

In a preferred embodiment, the cost to the merchant reserving the wall is directly related to one of the settings of size, time, location and visibility.

In a further embodiment the system has a tiered pricing model for a specific location based on the use of that location. For example, placing a wall at a sports venue may cost more than a wall located at a restaurant.

In a further embodiment a merchant reserving a wall is provided an option to purchase at the price specified or a reduced price in which they allow the system to display advertisements on or in relation to the wall.

In an alternative embodiment, the system is configured to enable merchants to create walls at no cost regardless of the time, size, location and visibility settings.

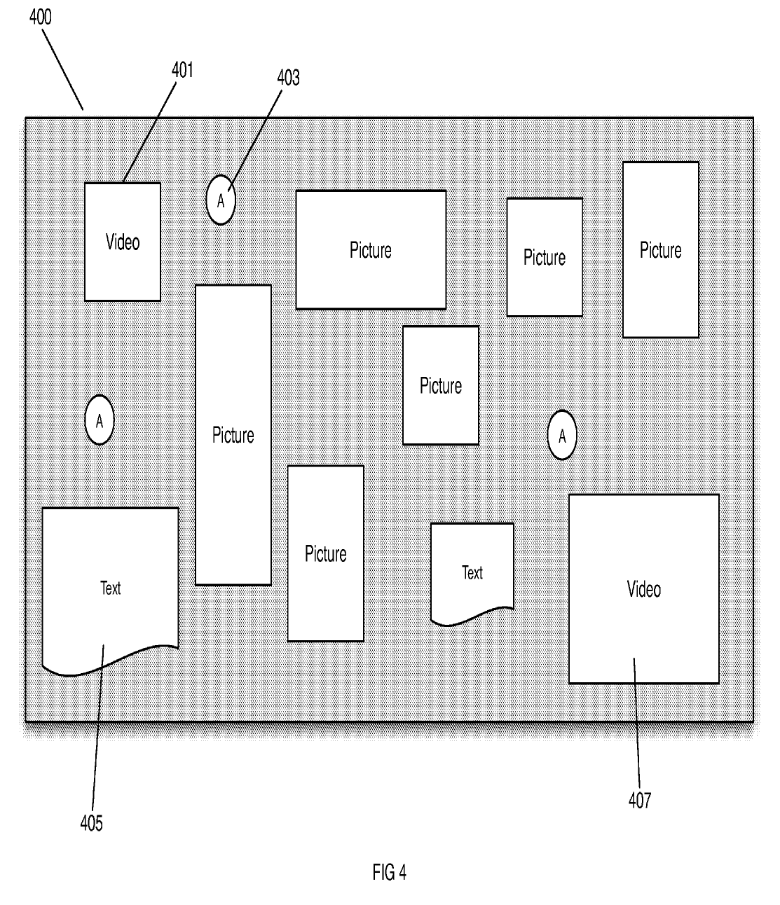

FIG. 4 is an illustration of one embodiment of a virtual wall combining various media types. The virtual wall 400 may be displayed within any standard web browser such as Internet. Explorer, Chrome, Firefox, or Safari. Content displayed on a virtual wall can be one or more of the following: video 401, audio 403, text 405 or a picture 407. When audio 403 is placed. on the virtual wall but not directly associated with a video, image or text it may be given a visual indicator 403. Both audio and text can be directly associated with video and images.

In a further embodiment, a merchant can place virtual items within their wall or in relation to their wall. For example, a merchant can utilize virtual items to decorate the top of their wall with flowers or a sponsored banner. Any virtual item can be utilized in association with a wall.

In an even further embodiment, the merchant can purchase the virtual items for their wall.

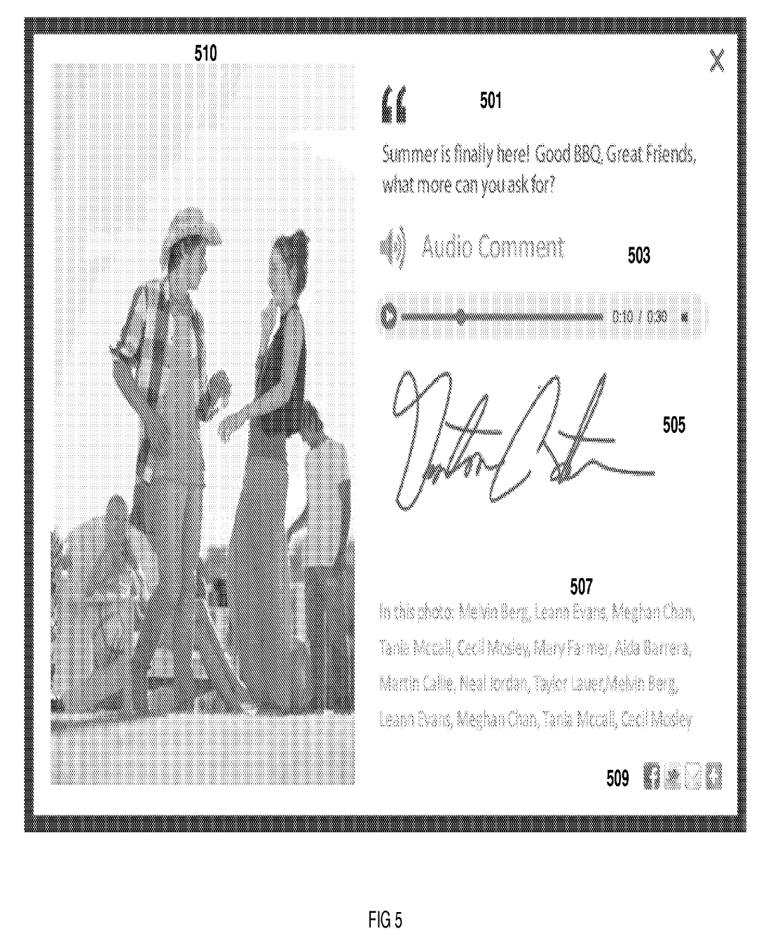

FIG. 5 is an illustration of one embodiment of a message within a virtual wall. The message has associated with it a picture 510, a comment 501, an audio comment 503, a signature 505, and tags that capture the people, places or other object associated with this specific message 507. The message also has sharing capability 509. Sharing can be done through any one of Facebook, Twitter, email or other social communication means. It is understood that the system is configurable to display messages with any combination of these elements, additional elements, or no elements at all.

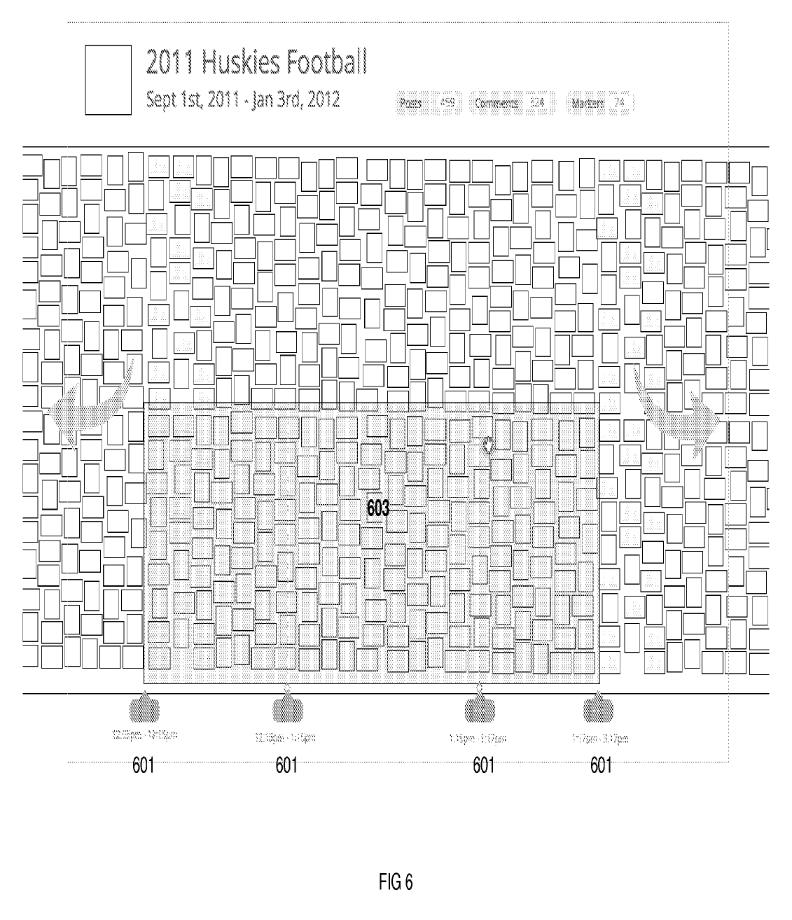

FIG. 6 is an illustration of one embodiment of a virtual wall with epochs highlighting events within a section of the wall. The illustrated embodiment shows a virtual wall at a virtual location. In this embodiment, the wall may be virtually located at Husky Stadium in Seattle. In this embodiment, the horizontal sides of the wall correspond to the dates from Sep. 1, 2011 to Jan. 3, 2012. The points furthest left on the wall correspond to Sep. 1, 2011; the points furthest. right on the wall correspond to Jan. 3, 2012; and the points in between correspond to the dates between. Sep. 1, 2011 and Jan. 3, 2012.

An “epoch” as described herein is a specific time, period of time, or event. For example and without limitation, an epoch. may be 5:30 p.m., 5:30 p.m.-7:30 p.m., or Thanksgiving.

Visual indicators 601 along the bottom of the wall illustrate epochs. In this embodiment, there are three epochs within the highlighted section of the wall 603. The midpoint of the leftmost visual indicator 601 corresponds to 12:05 p.m., while the midpoint of the second visual indicator (from the left) 601 corresponds to 12:15 p.m. Accordingly, in the illustrated embodiment, the portion of the wall between the midpoints of those two visual indicators corresponds to the epoch “12:05 p.m.-12:15 p.m.”.

Similarly, in the embodiment illustrated in FIG. 6, the epoch “12:15 p.m.-1:15 p.m.” is represented by the portion of the wall between the midpoints of the second visual indicator 601 and the third visual indicator (from the left) 601. The epoch “1:15 p.m.-1:17 p.m.” is represented by the portion n the wall between the midpoints of the third visual indicator 601 and the rightmost visual indicator 601. Another epoch outside the highlighted portion 603, “1:17 p.m.-3:17 p.m.”, is represented by the portion of the wall between the midpoint of the rightmost visual indicator 601 and the point furthest right on the wall.

Visual indicators for epochs can be placed at any point on a virtual wall. The system can further be configured to automatically zoom into a section or sub-section of a wall when an epoch is selected.

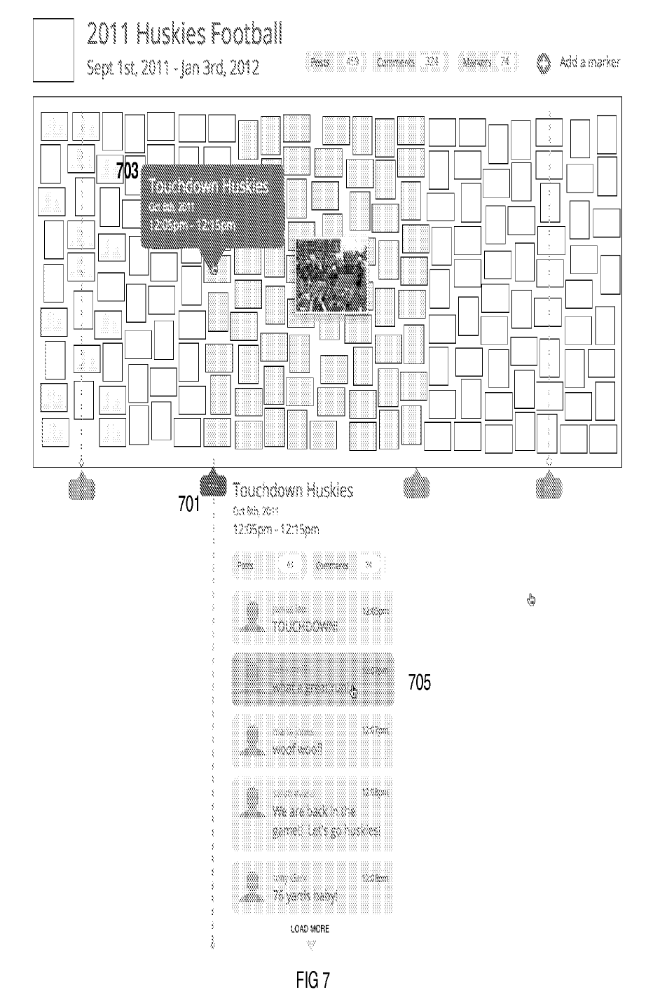

FIG. 7 is an illustration of one embodiment of a virtual wall with a list of messages from a selected epoch indicator. In this illustration, epoch indicators 701 are positioned along the bottom of the wall. When a user selects an epoch indicator, the messages associated with that epoch indicator are highlighted, and a list of the comments associated with messages are displayed 705. In this illustrated embodiment, each selected epoch indicator is associated with a particular epoch, that particular epoch being the epoch between the midpoint of the selected epoch indicator and the midpoint of the epoch indicator to the immediate right of the selected epoch. indicator. The system is configurable to indicate the message that represents the beginning message of the epoch 703 and the ending message.

It is understood that the system is configurable to display epoch indicators and associated messages. In an alternative embodiment, the indicators can be embedded within the messages of a wall.

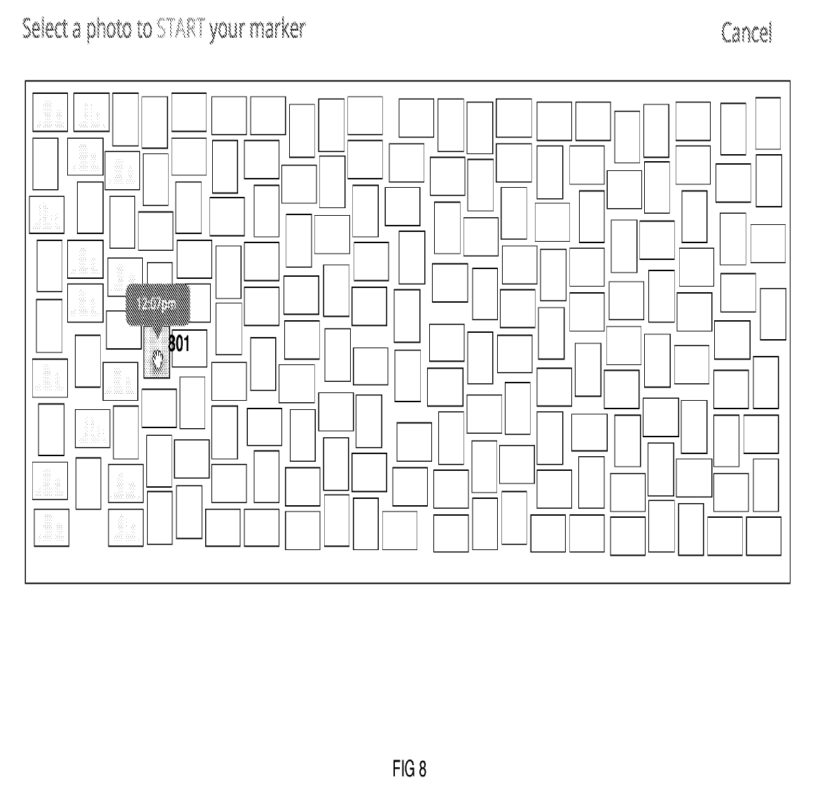

FIG. 8 is an illustration of one embodiment of a virtual wall on which a beginning message for an epoch has been selected. As discussed above, an epoch is a group of messages associated with one particular event or point in time or period of time. To select a group of messages the user selects the first message to be associated with a new epoch 801.

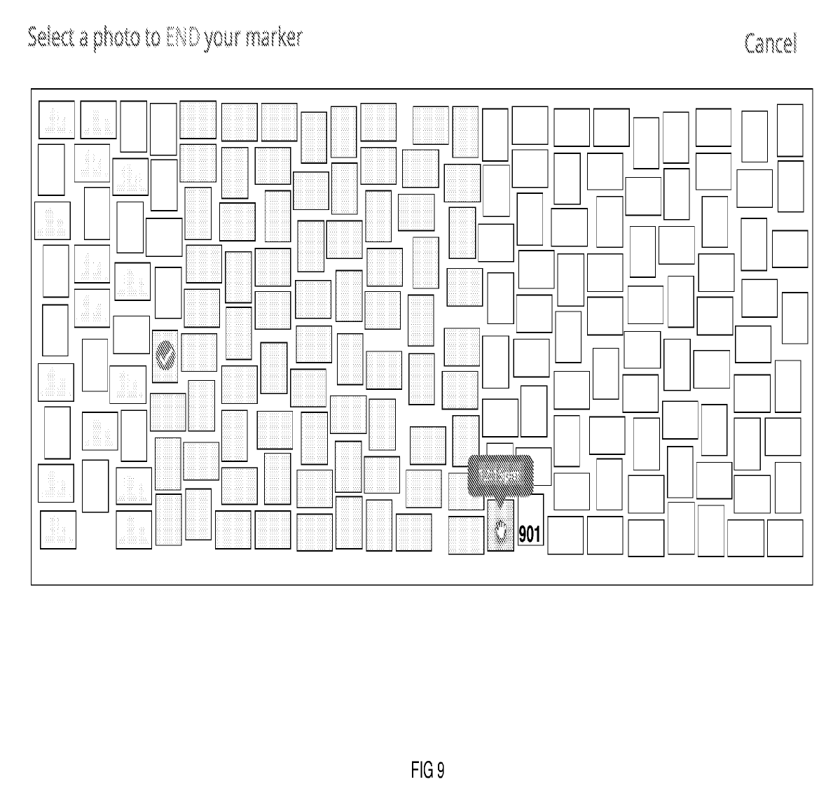

FIG. 9 is an illustration of one embodiment of a virtual wall on which an ending message for an epoch has been selected. The user selects the last message they want associated with a given epoch 901.

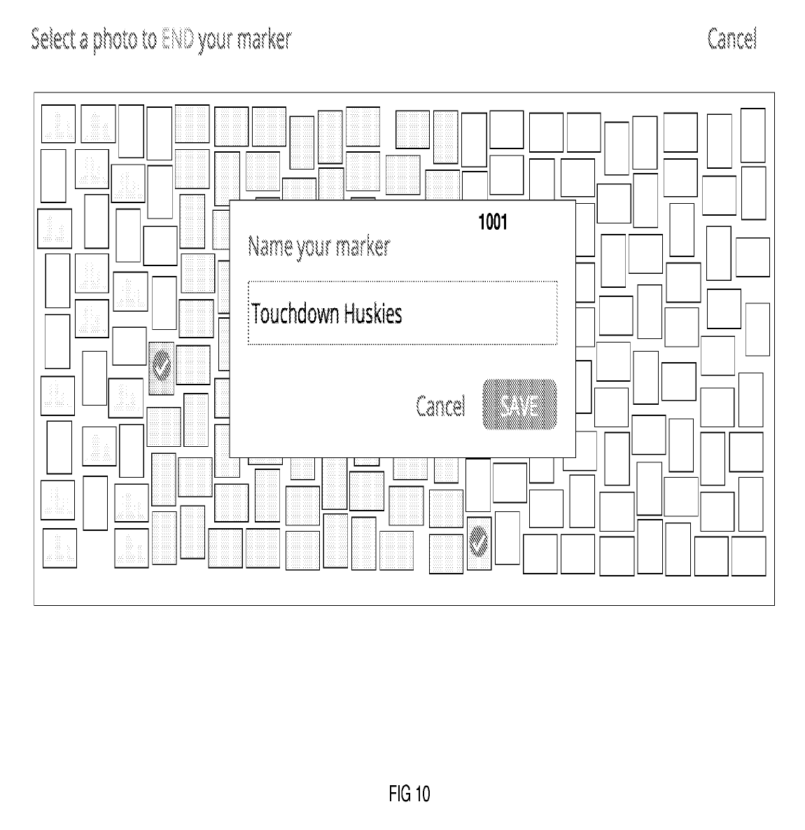

FIG. 10 is an illustration of one embodiment of a virtual wall on which an epoch has been named. Once a beginning message and end message has been selected, the user can name the epoch 1001.

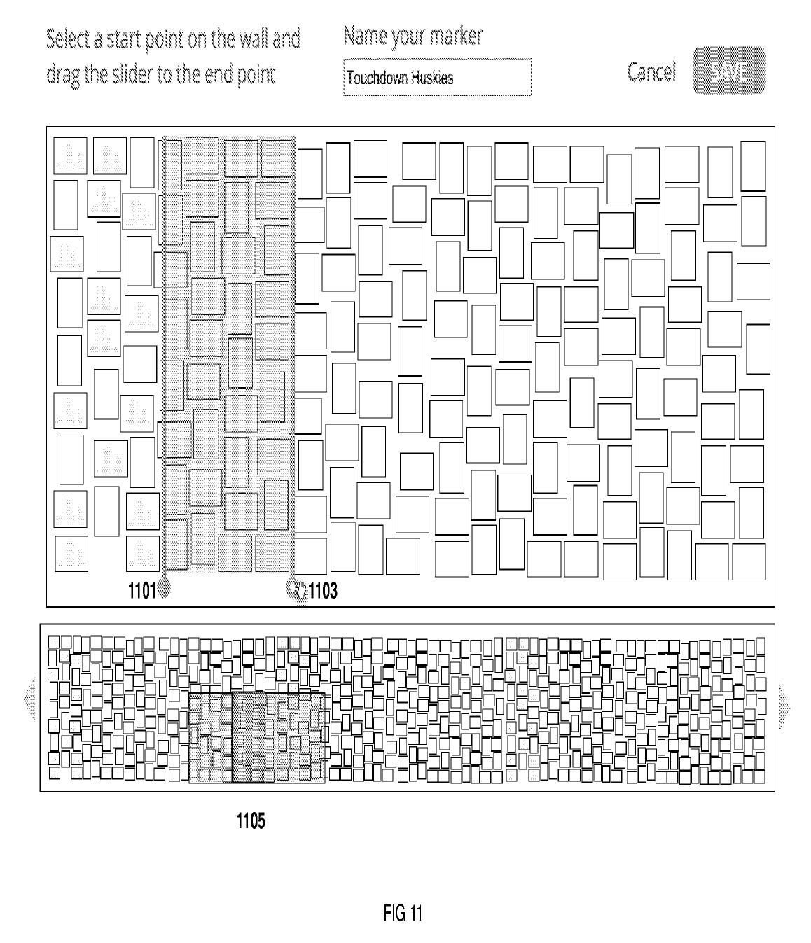

FIG. 11 is an illustration of another embodiment of a virtual wall on which an epoch has been named. In this embodiment, the user selects a beginning message on the wall 1101, then drags a visual indicator in a given direction to an end message 1103. The messages between the beginning and ending message represent the epoch. As described above, the user can name the epoch for identification purposes. Further, the user can select any section of the wall to create an epoch. As illustrated, the entire wall can be displayed 1105 separately from the section currently in primary view.

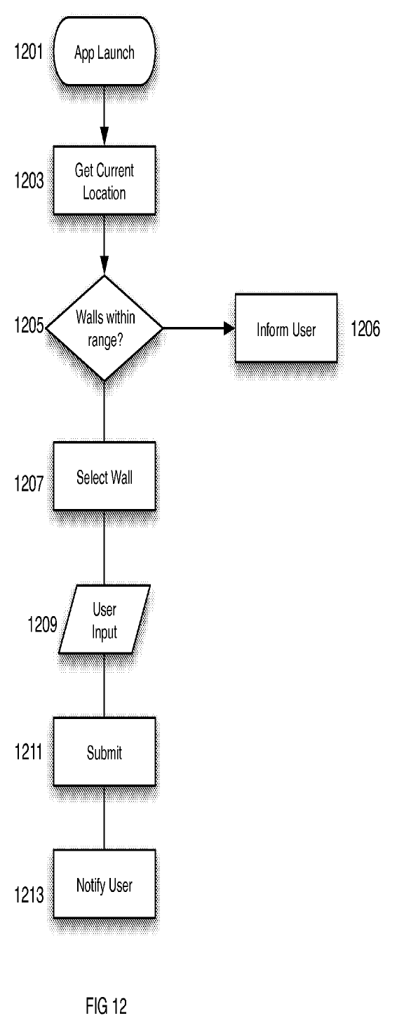

FIG. 12 is a flow chart detailing one embodiment of a method for determining the locations within which a user may post a message on a wall. The process begins when a mobile application is launched 1201. The application determines the current location 1203 of the user. Mobile devices through their associated operating system may, without limitation, provide an interface by which application can access Global Positioning Satellite (GPS) data or other location data. Once a current location is set, the application determines if there are any virtual walls within range 1205. If no walls are available at the current location, the application will inform the user 1206. As part of informing a user, the application can provide details about walls in close proximity to the user. For example, it could list walls that are within a mile. Further, the application can provide a directional indicator to locate a specific wall. If the user is at a valid location, the user is able to select the wall 1207 to post a message on. The user inputs their message 1209. The message can contain one of or any combination of photos, text messages, video, or audio. The user submits 1211 the message to the system. Next, the application notifies 1213 the user upon success or failure of the message being posted to the virtual wall.

In a further embodiment the application may require payment to post a message.

In an even further embodiment the location may be an portable object such as a person, boat, or car. Even further, the location can comprise a series of geographically different locations.

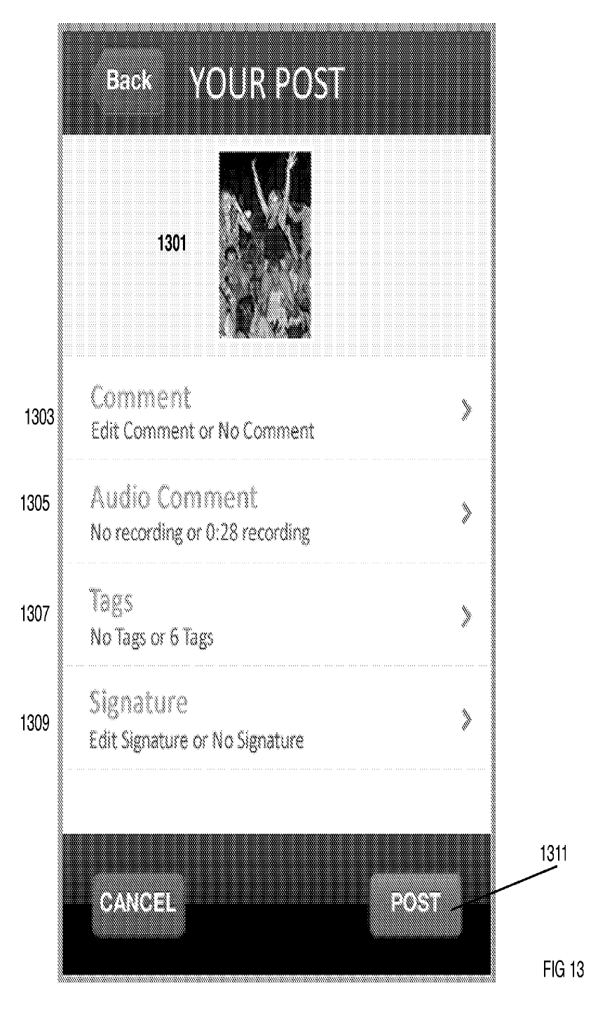

FIG. 13 is an illustration of one embodiment of a screenshot of a mobile application for posting a message on a virtual wall. In this illustration, the application already has the photo 1301 that will be uploaded to a wall. The user has a plurality of options to add additional information or content in conjunction with posting a message. The user can and a comment 1303. Further, the user can provide an audio comment 1305. Further, the user can tag 1307 people, places or event descriptions associated with the message. Even further, a user can provide a signature associated with the message 1309. Once a user has added additional information and content they select ‘post’ 1311 to send the message to the server for processing and display.

It is contemplated that any number of options to provide additional information and content, or no options, can be associated with a message. The specific options for additional information and content within a message can be specific to the type of message being posted. For example, a picture can have audio comments and a doodling feature that enables drawing on pictures. In contrast, a video message would not offer additional audio comments, and rather only offer tagging and signature. The mobile application, with available options to a user, is dynamic and configurable by the system.

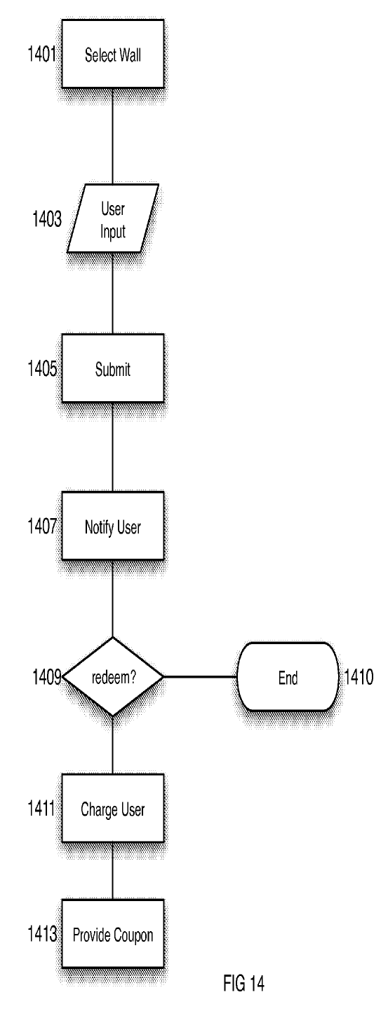

FIG. 14 is a flow chart of one embodiment of a method for providing a coupon after a user posts a message. The process begins when a user starts the mobile app and selects a wall 1401 to post a message on. The user inputs a message 1403 such as a picture, video, audio or text and submits 1405 the message the system. The process of capturing a message is described in detail above. The system, if configured, notifies 1407 the user of an available offer that is one of a coupon, discount purchase offer or other related advertisement based on their location and time. The user has the option to redeem the coupon and accept the offer 1409. If the use declines, the process ends 1410. If the user wants to redeem the coupon, the user is then charged the agreed upon price 1411. Once the system has authorized. payment, the system provides the coupon directly to the user via the mobile app 1413 for redemption.

In a further embodiment the system can be configured such that the coupon is free to the user and the user is not charged.

In a further embodiment the system can be configured so that advertisers can specify a target demographic for a specific venue. For example, an advertiser may know the demographic at a bar (for example, men whose ages are between 18 and 25 years) would likely want a coupon or advertisement for beer, whereas the demographic attending a movie would prefer a coupon for concessions.

If a user is unable to post a message using a mobile application the user can email the system a message containing text, photo, video or other content. Cameras capturing photos or video often embed geo-data, which identifies the geographical location a photo or video was recorded.

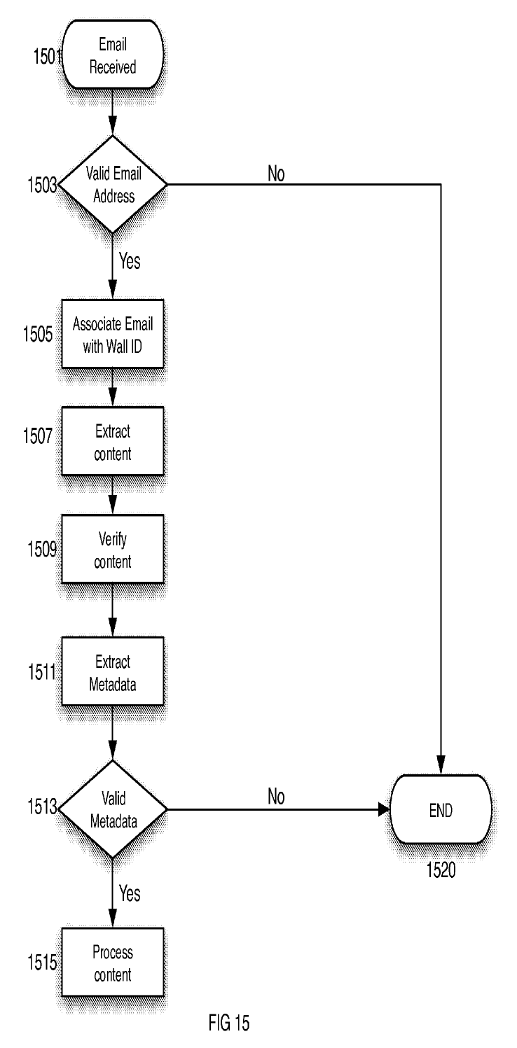

FIG. 15 is a flow chart detailing one embodiment of a method for the email receipt and processing of messages. The process begins 1501 when the system receives an email from a user. The system determines whether the email address from the recipient is valid 1503. If the email address is not valid, the email is deleted and process ends 1520. If the email address is valid, the email is associated with the wall ID 1505. A wall ID is a unique indicator used by the system to relate messages with a specific virtual wall. The wall ID is provided to a user to include in the email message to inform the system. Next, the content is extracted 1507 from the email message. Next, the content is verified 1509. The verification process can include one of verifying the system can support the content type, size, or virus checking. Any variety of verification processes can be implemented pending system requirements. Next, the system extracts the metadata 1511 from the content. Metadata includes the geo-location of the content. The geo-location, along with other required metadata, is verified 1513. If the location is not from the authorized wall location or time then the message is deleted and not processed 1520. If the metadata is verified to be from a valid location and time the content is processed for display on the virtual wall 1515.

Thus, in summary, it can be seen that what is described in this disclosure is a system for a web service that provides users the ability to reserve geographical area within a virtual system for the purposes to enabling individuals to provide content at a given location and time. Further disclosed is a web service that provides advertisements to individuals at specific geographical location during a specific time.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

What is claimed is:

1. A system for presenting information, comprising:
providing a virtual environment having a plurality of virtual walls, each virtual wall being associated with a real-world geographical location;
assigning at least one virtual wall to a merchant based on at least one criterion; and
posting content to the virtual wall assigned to the merchant, the content being generated by a user present in the real-world geographical location associated with the assigned virtual wall.

2. The system recited in claim 1, wherein the criterion is a selected one of a location, a location type, a size of area, a time, a length of time, or any combination thereof.

3. The system recited in claim 1, wherein the user is disallowed to post on the assigned virtual wall when the criterion is not satisfied.

4. The system recited in claim 3, wherein the assigned virtual wall is not displayed to users who do not satisfy the criterion.

5. The system recited in claim 1, wherein advertisements are presented on the assigned virtual wall for display to users present in the real-world geographical location of the assigned virtual wall.
